(19) United States
(12) Patent Application Publication
(10) Pub. No.: US 2011/0302959 A1
(43) Pub. Date: Dec. 15, 2011

(54) Precious stone setting

(76) Inventors: Adam Wcislo, Waterloo (CA); Zofia Anna Sawkiewicz, Waterloo (CA)

(21) Appl. No.: 12/801,508

(22) Filed: Jun. 11, 2010

(51) Int. Cl. A44C 17/02; B28D 5/00; B23P 5/00; A44C 17/00

(52) U.S. Cl. 63/26; 63/32; 125/30.01; 29/10

(57) ABSTRACT

The object of the present invention is a setting for a gemstone or diamond having a groove cut, based on gemstone or diamond shape, which acts as the setting. The groove in the gemstone or diamond is on the side surface or edge or other parameter which surrounds the face of the gemstone or diamond. The setting material is inserted into the groove and connected together outside or inside the groove, forming the frame around the gemstone or diamond. Once the frame is connected it becomes the setting.

### BACKGROUND OF THE INVENTION

In most cases a setting for a gemstone or diamond is build like a basket and has prongs sticking upwards which hold the gemstone or diamond, or a bezel setting for a gemstone or diamond, or the gemstone or diamond is trapped inside of a basket or a cage as the setting.

### SUMMARY OF THE PRESENT INVENTION

It is the object of the present invention to provide a gemstone or diamond and settings for gemstones or diamonds.

It is another object of the present invention to provide settings for gemstone or diamond having a groove cut based on gemstone or diamond shape which groove holds the setting.

It is another object of the present invention to provide a rigid setting with gemstone or diamond so amateur or professionals can attach any free-form art to the setting having a gemstone or diamond.

It is another object of the present invention, which distinguished itself from any other gemstone or diamond settings wherein the setting is holding the gemstone or diamond, opposed to the present invention wherein a gemstone or diamond is holding the setting.

### BRIEF DESCRIPTION OF THE DRAWINGS

FIG. 1 shows a gemstone or diamond from sight and top view, facet 4 and cabochon 5.

FIG. 2 shows the facet gemstone or diamond in three stages:

Stage 1: The edge of the gemstone or diamond—rigid base 1 as the starting material.

Stage 2: The same gemstone or diamond—rigid base 1 wherein the rectangle groove 3 is cut around the gemstone or diamond.

Stage 3: The same gemstone or diamond with rectangle setting 2 around the gemstone or diamond, which is the visible setting around the gemstone or diamond—rigid base 1.

FIG. 2A shows the facet gemstone or diamond—rigid base 1 in three stages, as shown on FIG. 2 but the gemstone or diamond—rigid base 1 has a groove which is angled 19 to the top surface of the rigid base 1.

FIG. 3 shows different shapes of the rigid base 1 as examples of settings cross-section in the present invention.

FIG. 4 shows the side view of a gemstone or diamond, examples of positions of the groove in relation to the top of gemstone or diamond, and examples of shape of the groove.

FIG. 5 shows examples of connected material as setting, with shown connecting line 13 as where the connecting of material was made.

FIG. 6 shows examples of finished product, the rigid base 1 with setting 2.

FIG. 7 shows examples of finished rigid base 1 that has a groove 33 cut lower then the biggest parameter into the side surface around the face of top surface of rigid base 1 as an opportunity for connecting groove 3 in the rigid base 1 with conventional setting.

### DETAILED DESCRIPTION OF THE PREFERRED EMBODIMENT

The present invention is based on the idea that a gemstone or diamond can be a rigid base 1 for a setting 2, instead of settings like basket with prongs, or bezel, or cage, or invisible mounting methods as the rigid base for holding gemstones or diamonds.

Referring to figures, numbers on figures indicate:

1: rigid base, 2: setting, 3: groove, 4: facet gemstone or diamond, 5: cabochon gemstone or diamond, 6: edge of facet gemstone or diamond, 7: insert, 8: top surface of gemstone or diamond, 9: side surface of gemstone or diamond, 11: side view of gemstone or diamond, 12: top view of gemstone or diamond, 13: an example of connected material as setting with shown connecting line—as where the connecting of material was made, 14: frame, 15: edge of the groove in gemstone or diamond, 16: edge of the groove out of gemstone or diamond, 18: the ring as an example of possibilities of using setting for extended function, 19: angle of groove, 20: rectangular shape groove, 20a: rectangular shape groove with extension, 21: round shape groove, 21a: round shape groove with extension, 22: elliptical shape groove, 23: “V” shape groove, 24: “U” shape groove, 25: round shape, 26: cushion shape, 27: trillion shape, 28: pear shape, 29: marquise shape, 30: triangle shape, 31: emerald shape, 32: oval shape, 33: groove cut lower then the biggest parameter into side surface around the face of top surface of rigid base 1, and 34: the biggest parameter around the face of top surface.

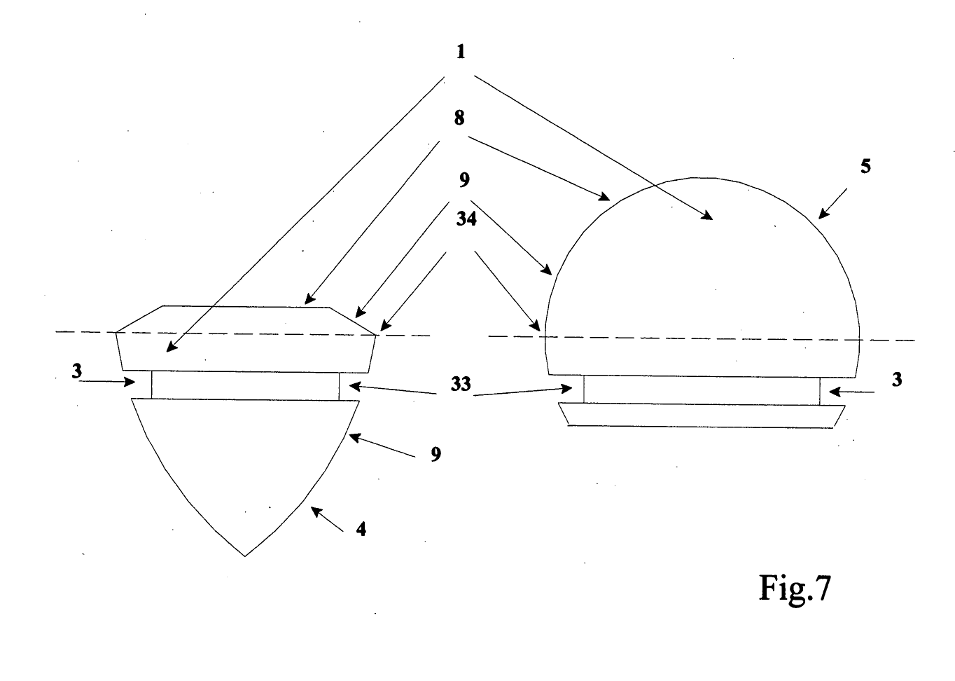

FIG. 7 shows examples of connecting groove 3 of present invention in the rigid base 1 with conventional setting such as the bezel setting, or prong setting, or engagement ring setting, where the top parts of the conventional settings are pinched/squeezed into the groove of present invention cut lower 33 then the biggest parameter around the top surface 8 of rigid base 1.

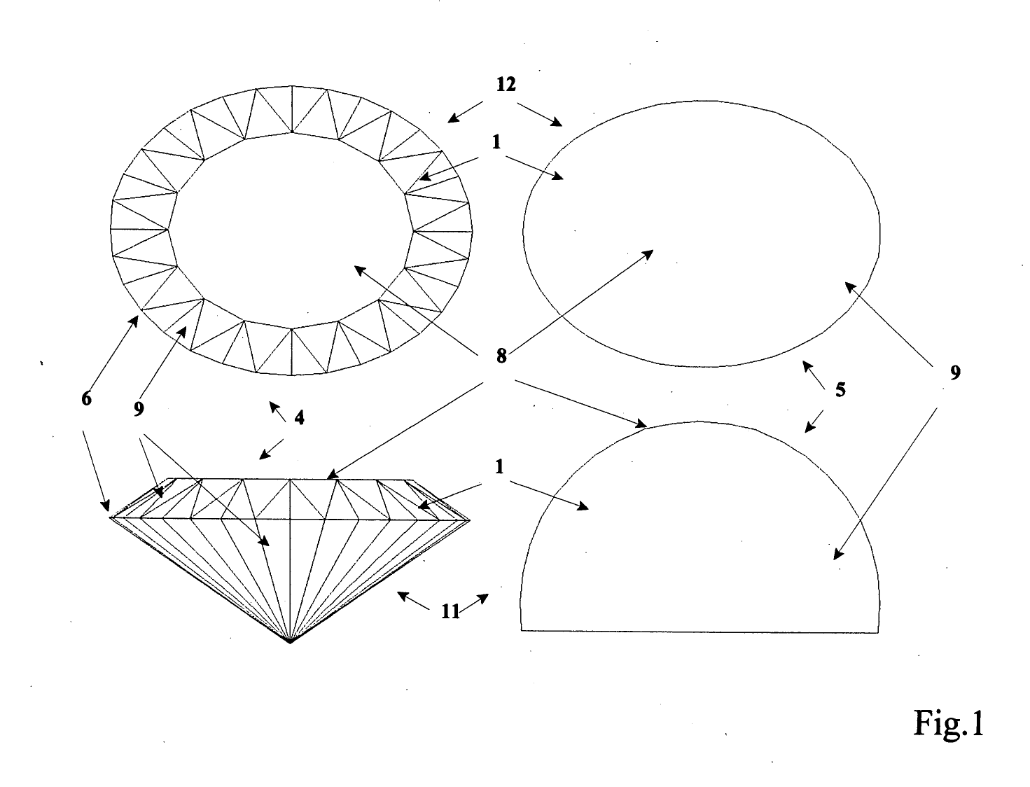

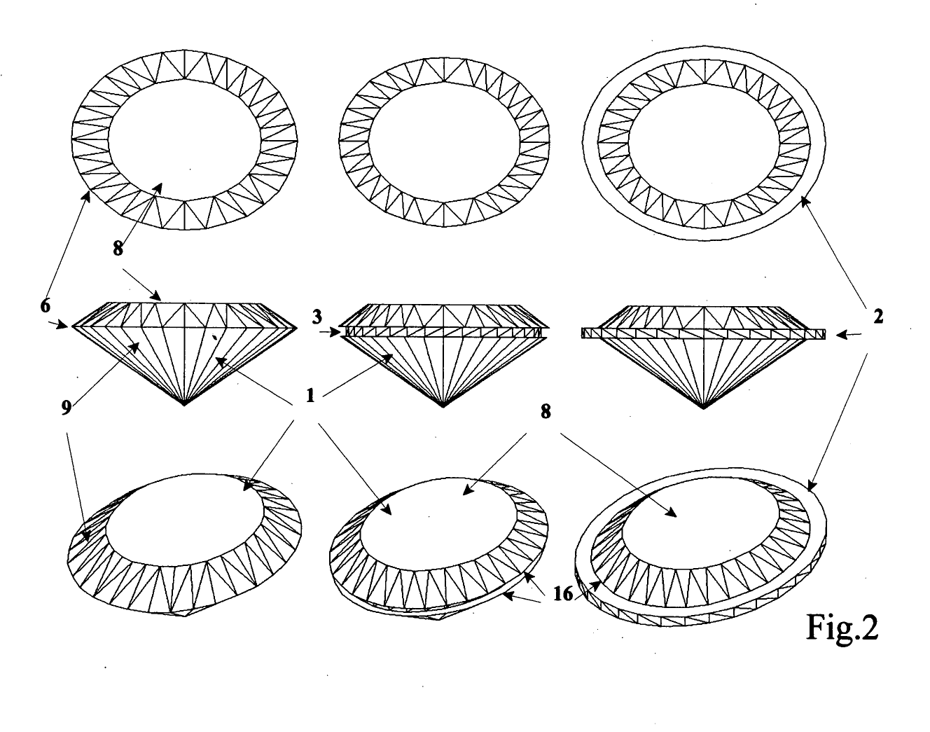

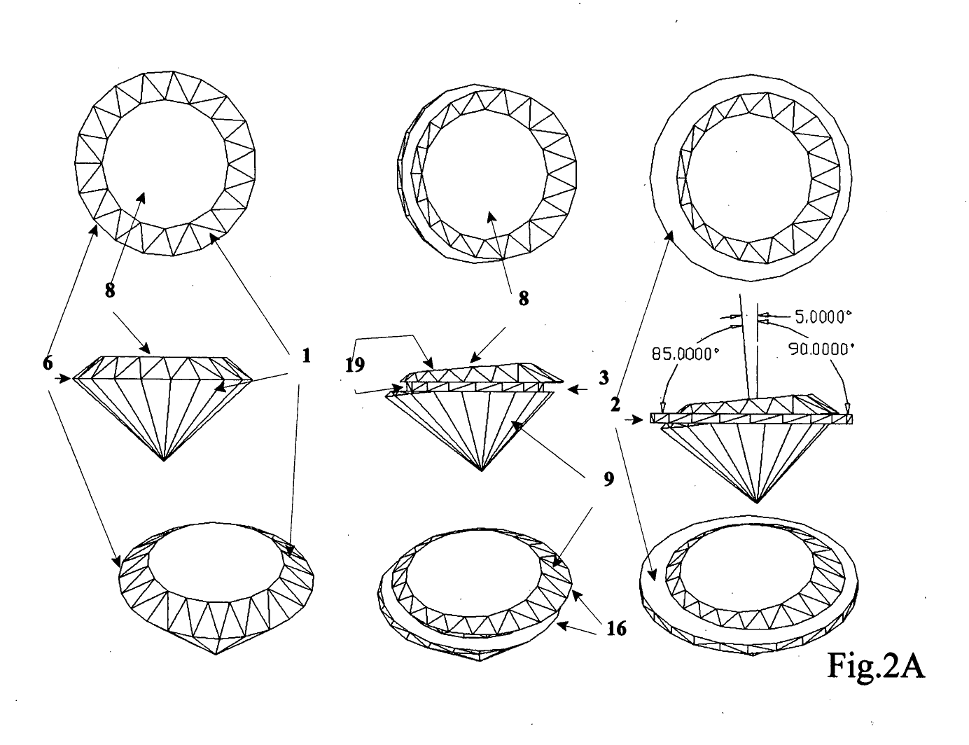

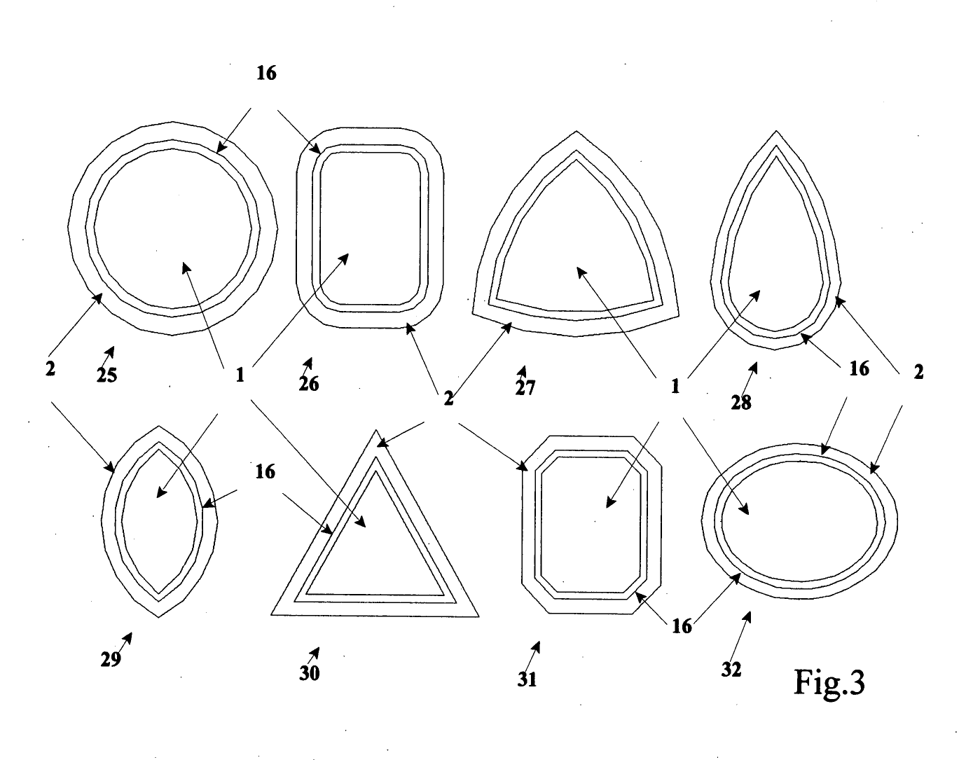

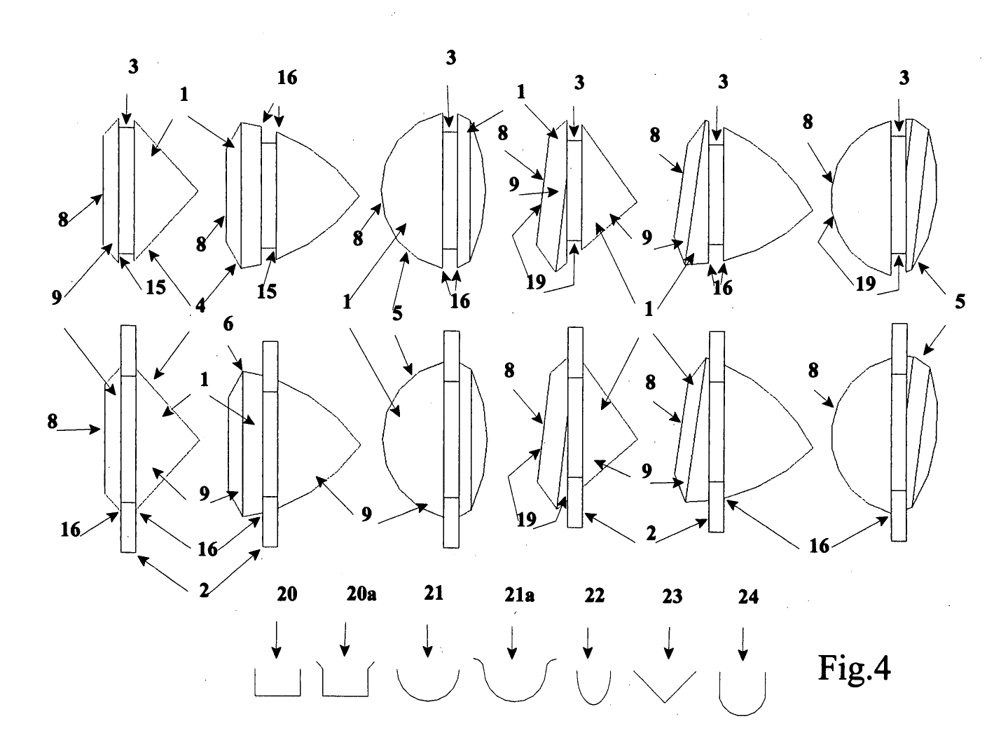

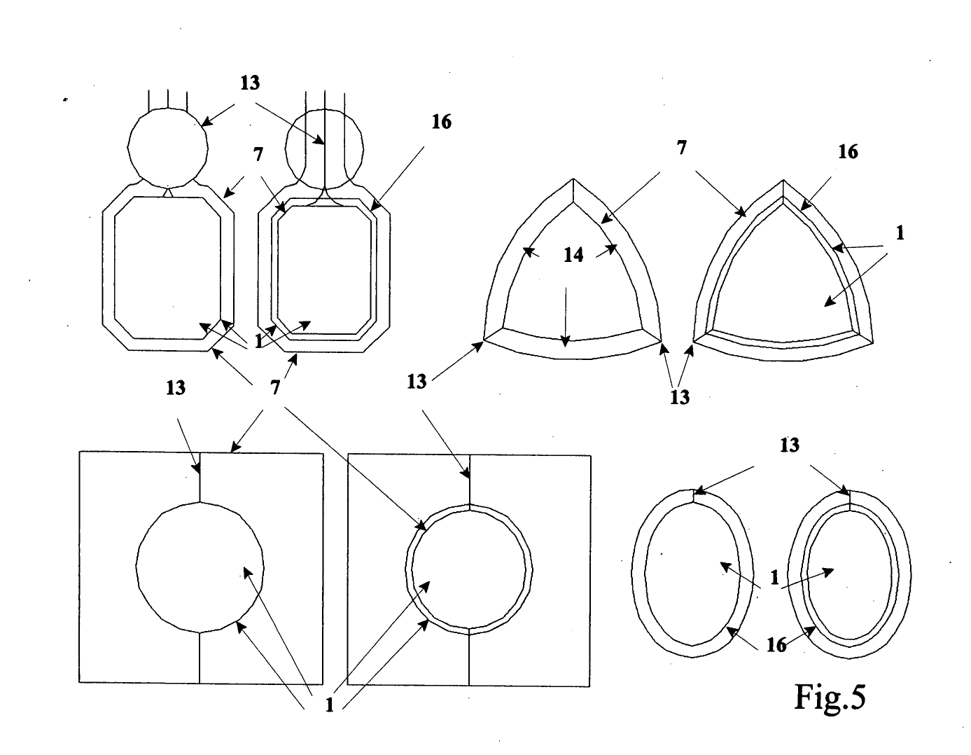

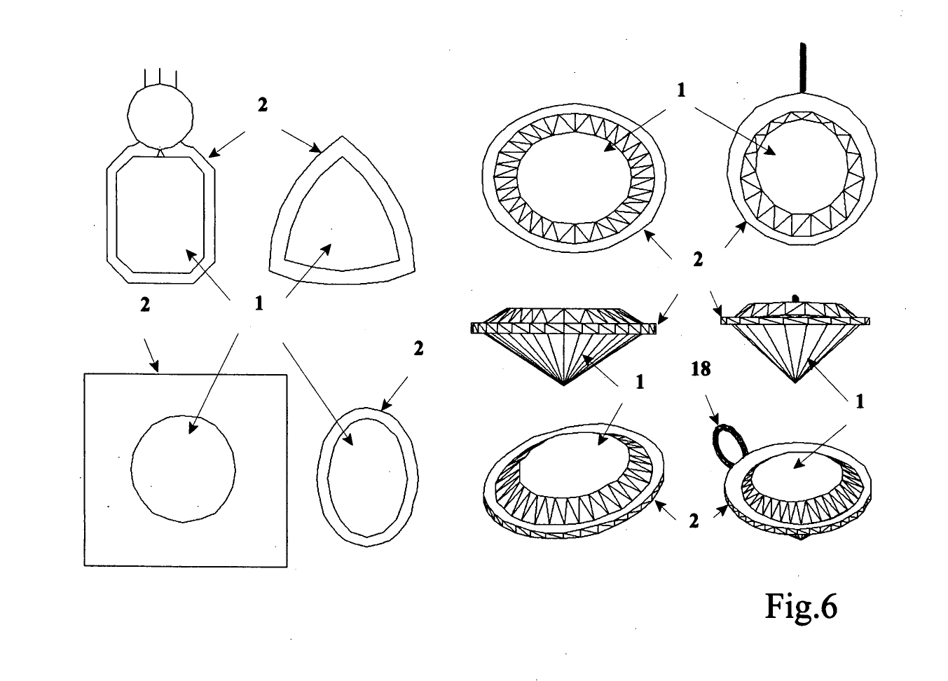

To start the process, a fully finished, grounded, cut, and polished gemstone or diamond is used as a rigid construction material (FIG. 1) to hold the setting. The gemstone or diamond is halted in the machine which has an ability to cut the groove into the side surface of gemstone or diamond. The machine uses a diamond wheel, or ceramic abrasive techniques, or a laser for example, to cut the groove around the face of the top surface of the gemstone, into the side surface and including the edge of the gemstone (FIG. 2, FIG. 3, and FIG. 4). It doesn't matter what the shape of the gemstones is used (FIG. 3). The gemstone shape guides the machine, or guidance is provided by a computer program product in the instance a C.N.C. machine is used to cut the groove in the gemstone. The position of the height and angle of cutting the groove into the side surface of the gemstone must be set before cutting the groove around the side surface of the gemstone (FIG. 4). The cross-section of the shape of the groove should be chosen for best feeding. The cross-section of the shape can be rectangular, round, elliptical, “V” shape, “U” shape, and the like, as presented on FIG. 4. Any shape can be used to achieve the desired/required effect. In most cases it will be cut into the biggest parameter surrounding the face of the gemstone, on the side of the gemstone, but in some cases cutting under or over the biggest parameter is used, depending on the desired/required effect (FIG. 2, FIG. 2A, and FIG. 4). After the cutting operation, the stone is placed into the holder for placement of the setting made of suitable precious metals such as platinum, gold, gold plated or gold filled, silver, titanium, stainless steel, in suitable shapes such as wire, tube, chain, mesh, rope, sheet, or cast metal, inside of the groove in the gemstone. The setting material (FIG. 5), wire for example, is inserted into the groove in the gemstone. The wire is tied together, and connected by welding, or spot-welding, or soldering, or any other mechanical or chemical connection to hold the wire inside of the groove and firmly into the groove in the gemstone (FIG. 5). Once the setting is connected outside or inside of the groove, one can build up any free-form art (FIG. 6), connecting to the setting a ring for example, which is rigidly held by the gemstone. The setting is visible and may be flat to the edge of gemstone, or side of gemstone, or stick out from the gemstone. In any event, it is very easy to see this setting from any angle view of a gemstone. FIG. 2, FIG. 3, and FIG. 6 show the setting material outside of the grove.

The finished product is a gemstone having a groove on the side surface or edge (FIG. 4) surrounding the face of the gemstone, wherein the setting material is inserted into the groove and connected together outside or inside the groove, forming a frame around the gemstone (FIG. 2, FIG. 3, FIG. 5 and FIG. 6). Once the frame is connected it becomes the setting, the principle of present invention. The setting and the gemstone become one piece. There is no way to separate this setting from the gemstone without cutting or otherwise destroying the setting of the present invention, opposed to other existing settings having prongs, or bezel, which can become bent or deformed, and the stone can be pulled out from the setting and put back or exchanged without destroying the setting.

Current patents try to find ways to hide the parts of the setting so only the stones will be visible and not the setting holding stones, but these typical settings use square or rectangular gemstones because they cannot use any other shape since they need parallel grooves to slide the gemstone into the setting. To make sure there is no misunderstanding, I include all shapes of gemstones, and exclude rectangular or square configuration gemstones with the purpose of being invisible gemstone setting, and having a groove to hide the setting. In existing patents is the same thing repeated, the rigid setting holds the gemstone (not the gemstone rigidly holding the setting) as the principle of present inventions. The present invention is a materially different product.

In other patents, the rigid setting holds the gemstone. As the principle of present inventions, the gemstone rigidly holds the setting. Without the gemstone, the setting will be very flexible and can bend and break anywhere, anytime, and because of the gemstone the setting is rigid and is easy to attach to it any free-form art by amateur for professionals.

The gemstone rigidly holds the setting inserted into the groove and connected inside or outside of the groove by welding, or spot-welding, or soldering, or any other mechanical or chemical connection to hold the setting inside of the groove.

The angle for the groove in gemstone for the setting should be from 0 to 15 degrees, depending on the gemstone shape, to provide the gemstone with the best effect wherein a light bouncing to the gemstone is going through the stone from its side surface and shooting through the face of the gemstone.

The easiest to manipulate the light is in the round stone, but using other shapes of stones also gives very rewarding effect.

Depending on the shape of stones, the angle of setting and shapes of the grooves filled with shiny metal changes, giving very interesting effects.

In application, one can also use a jump ring and solder into the setting and have a pendent.

One can also use the jump ring and solder into the setting, then take the second gemstone with such a setting and do the same, and then use the jump ring and place it inside of the jump rings to connect two settings together. If the setting is made by using a chain in the groove, the jump ring can be connected within the chain. Or, if the setting sticks far enough out from the gemstone, one can drill the hole and then use the jump ring through the hole in the setting, and do the same to another setting, and connect both settings together by a jump ring. If one uses more jump rings on one setting, than the jump rings can connect a few settings together and build-up the set with many gemstones, the possibilities are endless. For example, one can solder settings together and make a sculpture. By using welding, or soldering, or any other mechanical, or chemical connection with this kind of setting, the possibilities are endless (18 on FIG. 6).

The component of a jewelry-rigid base for the setting means diamonds or gemstones, whether synthetic or natural, having a refractive index of 1.440 to 3.220, including: Peridot, Topaz, Tourmaline, family of Quartz, Ruby, Sapphire, family of Garnet, Diamond, Emerald, Tanzanite, Iolite, Spodumene, Kunzite, Spinel, Moonstone, Moissanite, Citrine, Amethyst, Ametrine, Zircon, for example.

Technically it works like this:

A rigid base 1 for the setting 2 means: material (synthetic or natural) fully finished, grounded, cut, and polished with a refractive index from 1.440 to 3.220, includes: Alexandrite, Amethyst, Amber, Ametrine, Aquamarine, Apatite, Beryl, Diamond, Chrome Diopside, Citrine, Chrysoberyl, Diopside, Emerald, Garnet, Iolite, Kunzite, Kyanite, Morganite, Moissanite, Moonstone, Peridot, Quartz, Ruby, Star Ruby, Sapphire, Star Sapphire, Spinel, Spodumene, Tanzanite, Topaz, Tourmaline, Zircon, for example.

The rigid base 1 cross-section having a shape such as: 25 round, 26 cushion, 27 trillion, 28 pear, 29 marquise, 30 triangle, 31 emerald, 32 oval or the like, or free-form wherein the shape of rigid base is cut for special purpose.

The groove 3 in the rigid base means: groove 3 having shape 20 rectangular, 21 round, 22 elliptical, 23 “V” shape, 24 “U” shape, or their like, and cut on the side and into the side surface 9 including the edge 6 of the rigid base around the face of top surface 8 of the rigid base for frame 14 insert 7 wherein the cross-section of the groove 3 shape can be 20 rectangular, 21 round, 22 elliptical, 23 “V” shape, 24 “U” shape, or the like. The position of the height and angle of cutting groove 3 into the side surface 9 of the rigid base 1 must be set before cutting the groove around the top surface 8 of the rigid base.

The angle 19 of the groove in the rigid base should be suitable depending on the rigid base shape, and ranging from 0 to 15 degrees for the best combined effect of the rigid base 1 and frame 14. The cross-section of the shape of the groove should be chosen for best feeding. It could be any shape, considering frame and light to achieve desired/required effect.

A metal insert 7 for the frame 14 means: metals such as platinum, gold, gold plated or gold filled, silver, titanium, stainless steel, or other is inserted into the groove of the rigid base and connected 13 inside or outside the groove of the rigid base around the face of the top surface of the rigid base forming the frame.

Metal insert 7 shapes for frame means: shapes such as wire, tube, chain, mesh, rope, sheet, or cast metal, or the like.

A frame 14 means: selected metal of suitable shape inserted into the groove 3 in the rigid base 1 and connected 13 together outside or inside of the groove by welding, or spot-welding, or soldering, or any other mechanical or chemical connection, and forms a frame 14 around the top surface 8 of the rigid base 1.

A setting 2 means: the frame around the rigid base once connected together 13.

Once one has the groove 3, the opportunity presents itself and using the groove might be a good choice for connecting the groove in the rigid base 1 with a conventional setting. This type of connection between rigid base 1 and conventional settings have nothing to do with an invisible setting hidden inside of a setting. The bezel setting or prong settings are very visible all around the rigid base. There is no conflict or shared idea between invisible settings and the connection of conventional settings with the groove 3 of the present invention.

To make it obvious, the present invention is not using a rigid base having a rectangular or square shape wherein the parallel grooves are needed to slide the gemstone into the invisible setting. The invisible setting and all of this kind of settings only use square or rectangular gemstones or diamonds. They cannot use any other shape because they need parallel grooves to slide the gemstone or diamonds into the invisible parts of the invisible setting.

The use of a groove 3 for the present invention in the rigid base 1 has the exclusive right so the groove 3 of the present invention will not be used by existing techniques of bezel setting or prong settings which pinch/press on the side of a gemstone or diamond. A rigid base 1 without the groove, as existing settings, push the gemstone against the side surface of the gemstone or diamond and overlap the biggest parameter 34 of the gemstone or diamond via bezel setting or prong setting. Those settings never have or use any groove 3 in gemstones or diamonds—rigid base 1.

The ring 18 is an example of possibilities of settings for extended function.

The extended use of present invention includes the use of a groove as described herein the present invention 3 in the rigid base 1 claim the exclusive right of present invention to use this groove to squeeze the top of the bezel setting or prong setting into a groove cut lower 33 then the biggest parameter 34 into the side surface around the face of the top surface of the rigid base 1 of present invention.

The use of this groove 3 of present invention having the exclusive right means: the extended function 18 or use includes the use of the groove 3 in the rigid base 1 to squeeze the top of a conventional setting into the groove. The groove 3 is cut lower then the biggest parameter 33 into the side surface 9 around the face of the top surface 8 of the rigid base. But this is not the main goal of the present invention.

The parts of the invisible settings look like columns within rows. Those parts hold the gemstones or diamonds—rigid base 1 and are never visible, which is different than the settings of the present invention.

The main goal of the present invention is: an assembly of a rigid base 1 and a setting 2 wherein the rigid base cross-section having shape and is modified in such a way so the groove is cut around the top surface of the rigid base and into the rigid base side surface and the metal is inserted into the groove of the rigid base and the metal is connected to form the setting, wherein the rigid base function is to rigidly hold the setting in the groove which surrounds the top surface of the rigid base.

1. An assembly of a rigid base and a setting wherein the rigid base cross-section having a shape and the rigid base having a refractive index from 1.440 to 3.220, and is modified in such a way so a groove is cut around the top surface of the rigid base and into the side surface of the rigid base with a groove surrounding the top surface of the rigid base, and selected metal inserted into the groove through the rigid base and connected to form the setting, wherein the rigid base function is to rigidly hold the setting in the groove which surrounds the top surface of the rigid base.

2. The rigid base according to claim 1, wherein the rigid base is modified in such a way so a groove is cut in the side surface around the top surface of the rigid base and the position and the angle of the groove is tilted from 0 to 15 degrees in relation to the top surface of the rigid base which the groove surrounds on the top surface of the rigid base.

3. A groove in a rigid base wherein the groove cross-section having a shape is cut on and into the side surface including the edge of the rigid base around the face of the top surface of the rigid base, and the position and the angle of the groove in the rigid base is set in relation to the top surface of the rigid base, and the angle is ranging from 0 to 15 degrees.

4. The groove in the rigid base according to claim 3, wherein the bottom outside edge of the groove is used as the biggest parameter around the face of the top surface of the rigid base.

5. The groove in the rigid base according to claim 3, wherein at least one partial groove is cut on the side surface of the rigid base.

6. A metal frame wherein a metal insert is selected and inserted into a groove though a rigid base and connected together to form the setting around the top surface of the rigid base.
